(19) United States
(12) Patent Application Publication
(10) Pub. No.: US 2019/0375877 A1
(43) Pub. Date: Dec. 12, 2019

(54) CHEMICAL RESISTANT PUD FOR MICROFIBER NONWOVEN LEATHER APPLICATION AND THE METHOD

(71) Applicants: DOW GLOBAL TECHNOLOGIES LLC, Midland, MI (US); ROHM AND HAAS COMPANY, Philadelphia, PA (US)

(72) Inventors: Chao He, Shanghai (CN); Yi Zhang, Witchita, KS (US); Zhaobui Qu, Shanghai (CN); Chao Zhang, Shanghai (CN); Xiangyang Tai, Shanghai (CN)

(73) Assignees: Dow Global Technologies LLC, Midland, MI (US); Rohm and Haas Company, Collegeville, PA (US)

(21) Appl. No.: 16/331,859

(22) PCT Filed: Sep. 9, 2016
(86) PCT No.: PCT/CN2016/098519

§ 371 Date: Mar. 8, 2019

(51) Int. Cl. C08G 18/12; C08G 18/08; C08G 18/76; C08G 18/48; C08J 5/24; D06N 3/00; D06N 3/14

(52) U.S. Cl. CPC C08G 18/12; C08G 18/0871; C08G 18/7671; C08G 18/4829; C08G 18/4837; D06N 2211/28; C08J 5/24; D06N 3/0004; D06N 3/0011; D06N 3/146; C08J 2375/08; C08G 18/4812

(57) ABSTRACT

The present disclosure provides a polyurethane dispersion comprising a polyurethane prepolymer and an ionic surfactant. It further provides a microfiber nonwoven synthetic leather comprising a microfiber nonwoven fabric and the polyurethane dispersion. It further provides a method of preparing the microfiber nonwoven synthetic leather comprising a step of impregnating microfiber nonwoven fabrics into the polyurethane dispersion.

### FIELD OF THE DISCLOSUREDISCLOSURE

The present disclosure relates to novel chemical resistant polyurethane dispersions, application of same in microfiber nonwoven synthetic leather preparation, and application methods.

### BACKGROUND AND SUMMARY OF THE DISCLOSURE

Microfiber nonwoven synthetic leather is the best mimic to genuine leather in fibrils-like structure among artificial leathers. With the growing market of microfiber nonwoven synthetic leathers, research hotspots in this area increase dramatically. Microfiber nonwoven synthetic leather is typically made by impregnating nonwovens with solvent-based adhesives such as dimethylformamide (DMF) polyurethane resin to bond the materials and give them the mechanical properties and hand-feel similar to genuine leathers. These solvents vaporize during manufacturing and post manufacturing, which leads to potential health issues for the manufacturing staff, the end users of the synthetic leather, and the environment. With the developments of research, solvent free or waterborne polyurethane dispersions were used to replace typical solvent-based polyurethane resins. Polyurethane dispersion is an aqueous emulsion of polyurethane particles in water having high solid content, small particle size, and prolonged stability (up to six months or longer). However, typical polyurethane dispersions cannot stand for a very strict later-on toluene/alkaline dissolution process in microfiber nonwoven synthetic leather preparation, i.e., the inevitable high temperature or the contact with the toluene/alkaline solution.

Therefore, there is still a need for a novel polyurethane dispersion in the application of microfiber nonwoven synthetic leather preparation. Specifically, the novel polyurethane dispersion should be chemical resistant, especially to toluene and alkaline.

The present disclosure provides polyurethane dispersions comprising a polyurethane prepolymer and an ionic surfactant. The polyurethane prepolymer comprises, as polymerized units, by dry weight based on total dry weight of the polyurethane prepolymer, from 25 to 40%, a monomeric aromatic diisocyanate, and from 20 to 85%, a polyether polyol. The polyurethane prepolymer has an isocyanate content (“% NCO”) of from 3 to 10%.

The present disclosure further provides microfiber nonwoven synthetic leathers comprising a microfiber nonwoven fabric and the polyurethane dispersion.

The present disclosure further provides methods of preparing the microfiber nonwoven synthetic leathers comprising a step of impregnating microfiber nonwoven fabrics into the polyurethane dispersion.

### DETAILED DESCRIPTION OF THE DISCLOSURE

The polyurethane dispersions of the present disclosure are prepared by dispersing a polyurethane prepolymer into water with the assistance of an ionic surfactant.

The polyurethane prepolymer comprises, as polymerized units, by dry weight based on total dry weight of the polyurethane prepolymer, from 25 to 40%, or from 28 to 35%, and more or from 28 to 32%, a monomeric aromatic diisocyanate, and from 20 to 85%, or from 25 to 80%, or from 30 to 75%, a polyether polyol.

Optionally, the polyurethane prepolymer further comprises, as polymerized units, from 0.1 to 30%, or from 18 to 28%, or from 20 to 25% by dry weight based on total dry weight of the polyurethane prepolymer, a polyester polyol.

The monomeric aromatic diisocyanates or have a molecular weight Mw of less than 500 g/mol, or less than 300 g/mol, and more or less than 275 g/mol.

In some embodiments, the monomeric aromatic diisocyanates are selected from methylene diphenyl diisocyanate (MDI), toluene diisocyanate (TDI), and the combination thereof. TDI can be generally used with any commonly available isomer distributions. The most commonly available TDI has an isomer distribution of 80% 2,4-isomer and 20% 2,6-isomer. TDI with other isomer distributions can also be used. When MDI is used in the preparation of the polyurethane prepolymer, pure 4,4′-MDI can be used, or any combinations of MDI isomers. In some embodiments, pure 4,4′-MDI, and any combinations of 4,4′-MDI with other MDI isomers is used. When the combinations of 4,4′-MDI with other MDI isomers are used, the preferred concentration of 4,4′-MDI in the combination is from 25% to 75% of all MDI isomers.

Polyether polyols are the addition polymerization products and the graft products of ethylene oxide, propylene oxide, tetrahydrofuran, and butylene oxide, the condensation products of polyhydric alcohols, and any combinations thereof. Suitable examples of the polyether polyols include, but are not limited to, polypropylene glycol (PPG), polyethylene glycol (PEG), polybutylene glycol, polytetramethylene ether glycol (PTMEG), and any combinations thereof. In some embodiments, the polyether polyols are the combinations of PEG and at least one another polyether polyol selected from the above described addition polymerization and graft products, and the condensation products. In some embodiments, the polyether polyols are the combinations of PEG and at least one of PPG, polybutylene glycol, and PTMEG.

The polyester polyols are the condensation products or their derivatives of diols, and dicarboxylic acids and their derivatives.

Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl-1,3-propandiol, 1,3-butanediol, 1,4-butanediol, 1,6-hexanediol, neopentyl glycol, 3-methyl-1,5-pentandiol, and any combinations thereof. In order to achieve a polyol functionality of greater than 2, triols and/or tetraols may also be used. Suitable examples of such triols include, but are not limited to, trimethylolpropane and glycerol. Suitable examples of such tetraols include, but are not limited to, erythritol and pentaerythritol.

Dicarboxylic acids are selected from aromatic acids, aliphatic acids, and the combination thereof. Suitable examples of the aromatic acids include, but are not limited to, phthalic acid, isophthalic acid, and terephthalic acid; while suitable examples of the aliphatic acids include, but are not limited to, adipic acid, azelaic acid, sebacic acid, glutaric acid, tetrachlorophthalic acid, maleic acid, fumaric acid, itaconic acid, malonic acid, suberic acid, 2-methyl succinic acid, 3,3-diethyl glutaric acid, and 2,2-dimethyl succinic acid. Anhydrides of these acids can likewise be used. For the purposes of the present disclosure, the anhydrides are accordingly encompassed by the expression of term “acid”. In some embodiments, the aliphatic acids and aromatic acids are saturated, and are respectively adipic acid and isophthalic acid. Monocarboxylic acids, such as benzoic acid and hexane carboxylic acid, should be minimized or excluded.

Polyester polyols can also be prepared by addition polymerization of lactone with diols, triols and/or tetraols. Suitable examples of lactone include, but are not limited to, caprolactone, butyrolactone and valerolactone. Suitable examples of the diols include, but are not limited to, ethylene glycol, butylene glycol, diethylene glycol, triethylene glycol, polyalkylene glycols such as polyethylene glycol, 1,2-propanediol, 1,3-propanediol, 2-methyl 1,3-propandiol, 1,3-butanediol, 1,4-butanediol, 1,6-hexanediol, neopentyl glycol, 3-methyl 1,5-pentandiol and any combinations thereof. Suitable examples of triols include, but are not limited to, trimethylolpropane and glycerol. Suitable examples of tetraols include erythritol and pentaerythritol.

The polyether polyol and the polyester polyol each has a molecular weight Mw of from 400 to 4000 g/mol, or from 750 to 3500 g/mol, or from 800 to 3000 g/mol. The polyether polyol and the polyester polyol each has a functionality of from 1.8 to 4, or from 1.9 to 3, or from 2 to 2.5.

The preparation of the polyurethane prepolymer is in any way known to those of ordinary skill in the art, and includes condensation polymerization. The stoichiometry of the polyurethane prepolymer formulation disclosure is such that the diisocyanate is present in excess, and the polyurethane prepolymer is NCO group terminated. In some embodiments, the polyurethane prepolymer has an isocyanate content (also known as % NCO, as measured by ASTM D2572) of from 3 to 10%, or from 4 to 9%, or from 5 to 8%.

Organic solvent is preferably not used in the preparation of the polyurethane prepolymer.

In the practice of preparing the polyurethane dispersion of the present disclosure, an ionic surfactant can be introduced into the polyurethane prepolymer prior to the addition of water, but it is not outside the scope of the present disclosure that the surfactant is introduced into water prior to the addition of the polyurethane prepolymer.

The ionic surfactant is from 0.5 to 10%, or from 1 to 8%, or from 1.5 to 6% by dry weight based on total dry weight of the polyurethane dispersion.

The ionic surfactant can be anionic. Suitable examples of the anionic surfactants include, but are not limited to, sulfonates, phosphates, carboxylates, and any combinations thereof. In some embodiments, the anionic surfactant is sulfonate such as sodium dodecyl benzene sulfonate, sodium dodecyl sulfonate, sodium dodecyl diphenyl oxide disulfonate, sodium n-decyl diphenyl oxide disulfonate, isopropylamine dodecylbenzenesulfonate, and sodium hexyl diphenyl oxide disulfonate. In some embodiments, the anionic surfactant is sodium dodecyl benzene sulfonate.

When making the polyurethane dispersion, the prepolymer may be extended by water alone or may be extended using a chain extender, such as chain extenders known in the art or later discovered. When used, the chain extender may be any isocyanate reactive polyamine or amine having another isocyanate reactive group and a molecular weight of from 60 to 450 g/mol. Suitable examples of the chain extenders include, but are not limited to, ethylenediamine (EDA), 1,2- and 1,3-diaminopropane, 1,4-diaminobutane, 1,6-diaminohexane, isophorone diamine, aminated polyether diol, peperazine, aminoethylethanolamine (AEEA), ethanolamine and any combinations thereof. In some embodiments, the chain extender is from 0.1 to 8%, or from 0.2 to 6%, or from 0.5 to 5% by dry weight based on total dry weight of the polyurethane dispersion.

In some embodiments, the polyurethane dispersion further comprises one or more known or later-discovered additives selected from the group consisting of water, rheology modifiers, fillers, flame retardants, pigments, flowing additives, hand-feeling additives, antioxidants, anti-UV additives, and combinations of two or more thereof.

Microfiber nonwoven synthetic leather is a microfiber nonwoven that is impregnated with polymers such as polyurethane that may have a polymer coating later thereon.

In one embodiment, microfiber nonwoven fabrics are directly impregnated with the polyurethane dispersion of the present disclosure to produce microfiber nonwoven synthetic leather. The microfiber nonwoven fabrics comprise fibers, such as “islands-in-the-sea” type fibers. The “sea” component of the fiber can be dissolved, resulting in bundles of superfine fibers with small dimensions. The obtained fabric has a soft and pliable feel. The polyurethane dispersion of the present disclosure may resist the conditions encountered when dissolving the “sea” component from the islands-in-the-sea type fibers.

Processes for producing microfiber nonwoven fabrics include those known in the art or later discovered. Typically, an “islands-in-the-sea” type fiber with two components is prepared by feeding two polymers into a spinneret such that the “sea” component encircles the other “island” filament component, i.e., fiber spinning the two components. The “sea” component is typically soluble in organic solvents, such as a toluene or alkaline solution. The “sea” component can comprise a polyethylene (PE) or a polyethyleneterephthalate (PET), and the “island” component is usually insoluble and can comprise a polyamide (PA).

The weight ratio between the “island” component and the “sea” component used in the two components fiber spinning can be between 20:80 and 80:20. In some embodiments, the weight ratio between the components is 50:50.

The polyurethane dispersion may have any suitable solids loading of polyurethane particles. In some embodiments, the solids loading is from 1% to 50% by weight of solids, based on the total dispersion weight, to facilitate the impregnation into the nonwoven fabric.

The polyurethane dispersion may also contain a rheological modifier such as thickeners that enhance retention of the dispersion in the nonwoven fabric prior to coagulation. Any suitable rheological modifier may be used, such as those known in the art and later discovered. In some embodiments, the rheological modifier is one that does not cause the dispersion to become unstable. Suitable examples of the rheological modifiers include, but are not limited to, methyl cellulose ethers, alkali swellable thickeners (e.g., sodium or ammonium neutralized acrylic acid polymers), hydrophobically modified alkali swellable thickeners (e.g., hydrophobically modified acrylic acid copolymers) and associative thickeners (e.g., hydrophobically modified ethylene-oxide-based urethane block copolymers). The amount of thickener may be any useful amount, and is typically from 0.1% to 5% by weight based on total weight of the polyurethane dispersion. In some embodiments, the amount of thickener is from 0.3 to 2%, while the viscosity of the polyurethane dispersion is controlled from 1000 to 12000 mPa·s at room temperature, as measured by BROOKFIELD™ LV-T viscometer using spindle 3 at speed 6.

Other additives such as those known in the art and later discovered may also be added to the polyurethane dispersion to impart desired characteristics such as enhanced softness or improved ultraviolet stability to the impregnated microfiber nonwoven synthetic leather.

The polyurethane dispersion is impregnated by any suitable methods known in the art or later discovered, including dipping, spraying, or doctor-blading. After impregnating, the impregnated microfiber nonwoven fabrics may have excess dispersion or water removed to leave the desired amount of dispersion within the microfiber nonwoven. Typically, this may be accomplished by passing the impregnated textile through rubber rollers, with a general polyurethane impregnated amount (add-on amount) being from 200 to 1200 g/m² by dry weight. The impregnated microfiber nonwoven fabric is subsequently dried at a temperature from 100 to 130° C. in an oven for 5 to 20 minutes to form an impregnated base fabric. Then the fabric is subjected to a toluene or alkaline dissolution process to remove the “sea” component of microfiber to form a microfiber nonwoven synthetic leather base.

### EXAMPLES

Relevant raw materials used in the Examples are detailed in Table 1.

TABLE 1
Raw Materials

| Component | Description | | Supplier |
|---|---|---|---|
| Sodium hydroxide (NaOH) | >98.0% | | Sinopharm Chemical |
| | | | Reagent Co., Ltd. |
| Toluene | >98% | | Sinopharm Chemical |
| | | | Reagent Co., Ltd. |
| Diphenylmethane diisocyanate | >97.0% | (T) | TCI Chemical Industry |
| (MDI) | | | Co., Ltd. |
| Isophorone diisocyanate (IPDI) | >99.0% | (GC) | TCI Chemical Industry |
| | | | Co., Ltd. |
| VORANOL ™ 9287 polyether | Mn of 2000 | | Dow Chemical Company |
| polyol | | | |
| CARBOWAX ™ | Mn of 1000 | | Dow Chemical Company |
| methoxypolyethylene glycol | | | |
| (MPEG) | | | |
| RHODACAL ™ DS-4 | Sodium dodecyl benzene | | Solvay Company |
| | sulphonate (SDBS) | | |
| Aminoethylethanolamine (AEEA) | >99.0% | (GC)(T) | TCI Chemical Industry |
| | | | Co., Ltd. |

| | | |
|---|---|---|
| Ethylenediamine (EDA) | >98% | Sinopharm Chemical |
| | | Reagent Co., Ltd. |
| IMPRANIL ™ DL 1380 aliphatic | — | Covestro Company |
| isocyanate based polyurethane | | |
| dispersion | | |

### II. Processes

1. Toluene Resistance Evaluation

4 g of each polyurethane dispersion described below (35 wt %) is added to a dish with a diameter of 9.5 cm and held for 24 to 48 hours to evaporate the water. After the water is removed, the dish is baked at 130° C. for 20 minutes. Polyurethane dispersion films are then cut and weighed (Weight One (g)), and then put in a refluxing toluene at 130° C. for dissolution. In 3 hours dissolution, the retaining films are dried at 130° C. for 20 minutes, then weighed (Weight Two (g)). Weight Two is divided by Weight One to calculate the Retaining (%).

2. Alkaline Resistance Evaluation

4 g of each polyurethane dispersion, described below, (35 wt %) is added to a dish with a diameter of 9.5 cm and held for 24 to 48 hours to evaporate the water. After the water is removed, the dish is baked at 130° C. for 20 minutes. Polyurethane dispersion films are then cut and weighed (Weight One (g)), and then put in a refluxing NaOH (10 wt %) at 130° C. for dissolution. In 3 hours dissolution, the retaining films are dried at 130° C. for 20 minutes, then weighed (Weight Two (g)). Weight Two is divided by Weight One to calculate the Retaining (%).

3. Toluene Resistance Evaluation of Microfiber Nonwoven Synthetic Leather

Microfiber nonwoven fabrics are weighed (Weight One (g)) and then dipped into the polyurethane dispersion (25 wt %) for 10 seconds, followed by pressing the impregnated microfiber nonwoven fabrics with gap-controlled rollers. After that, the impregnated microfiber nonwoven fabrics are dried in a 90° C. oven for 10 minutes and then at 150° C. for 20 minutes, and then weighed (Weight Two (g)). The dried microfiber nonwoven fabrics are dipped into refluxing toluene (about 130° C.) for about 3 hours, dried at 130° C. for 20 minutes, and then weighed (Weight Three (g)). Retaining is calculated according to the following equation: (Weight Three−Weight one/2)/(Weight Two−Weight one). Two tests for each sample are conducted.

### III. Examples

### 1. Illustrative Example 1 (IE1)

680 g VORANOL™ 9287 polyether polyol and 20 g CARBOWAX™ methoxypolyethylene glycol are added and mixed in a 5000 ml round three-necked glass flask equipped with a mechanical dispersator, a drop funnel, and a tube for gas introduction. The mixture is under nitrogen flow over night, and then heated at 130° C. for 1 hour to remove water.

300 g diphenylmethane diisocyanate and 0.042 g benzoyl chloride are added under nitrogen flow to a 500 ml round three-necked glass flask equipped with a mechanical dispersator, a drop funnel, and a tube for gas introduction, and heated to 80° C. The dried mixture prepared above is added to the 500 ml flask and reacted at 80° C. for 4 hours, then cooled to room temperature to prepare the prepolymer.

270 g of the prepolymer and 35.7 g RHODACAL™ DS-4 sodium dodecyl benzene sulphonate are added to a 1 L plastic beaker and stirred at 3000 rpm with a mechanical dispersator. 152 g ice water is then slowly poured into the beaker and stirred at 400-500 rpm. 66 g aminoethylethanolamine is then added into the beaker. The mixture is then held for one week to degas. The resulting product is the Illustrative Polyurethane Dispersion Example 1 (IE1).

### 2. Illustrative Example 2 (IE2)

Illustrative Polyurethane Dispersion Example 2 (IE2) is prepared according to the same procedure of preparing Illustrative Polyurethane Dispersion Example 1 (IE1), but using a different chain extender, ethylenediamine.

### 3. Comparative Example 1 (CE1)

Comparative Polyurethane Dispersion Example 1 (CE1) is prepared according to the same procedure of preparing Illustrative Polyurethane Dispersion Example 1 (IE1), but using a different isocynate, 266.4 g isophorone diisocyanate at the same concentration.

### 4. Comparative Example 2 (CE2)

Comparative Polyurethane Dispersion Example 2 (CE2) is IMPRANIL™ DL 1380 aliphatic isocyanate based polyurethane dispersion commercially available from Bayer Company.

### 5. Comparative Examples 3 and 4 (CE3 and CE4)

Comparative Polyurethane Dispersion Examples 3 and 4 (CE3 and CE4) are prepared according to the same procedure of preparing Illustrative Polyurethane Dispersion Example 1 (IE1), but using 154 g of diphenylmethane diisocyanate, and different chain extenders.

Detailed components of each Polyurethane Dispersion Examples are shown in Table 2.

TABLE 2
Examples Compositions

| | Isocyanate | | Prepolymer | | Solid |
|---|---|---|---|---|---|
| | (wt % based | | NCO residue | Chain | content |
| Examples | on prepolymer) | | (%) | extender | wt % |
| IE1 | 30% | MDI | 7.1 wt % | AEEA | 53-54 |
| IE2 | 30% | MDI | 7.1 wt % | EDA | 30 |
| CE1 | 27.6% | IPDI | 7.1 wt % | AEEA | 42 |
| CE2: | IMPRANIL ™ DL 1380 aliphatic isocyanate | | | | 58 |
| | basedpolyurethane dispersion | | | | |
| CE3: | 18% | MDI | 2.5 wt % | EDA | 42 |
| CE4 | 18% | MDI | 2.5 wt % | AEEA | 42 |

### IV. Results

TABLE 3
Toluene Resistance

| | Weight One (g) | Weight Two (g) | Retaining (%) |
|---|---|---|---|
| IE1 | 0.4488 | 0.4384 | 97.7 |
| IE2 | 0.4696 | 0.4581 | 97.5 |
| CE1 | 0.4864 | 0 | 0 |
| CE2 | 0.6237 | 0 | 0 |
| CE3 | 0.4671 | 0 | 0 |
| CE4 | 0.4700 | 0.0865 | 18.4 |

TABLE 4
Alkaline Resistance

| | Weight One (g) | Weight Two (g) | Retaining (%) |
|---|---|---|---|
| IE1 | 0.5589 | 0.5587 | 100.0 |
| CE1 | 0.4082 | 0.3502 | 85.8 |
| CE2 | 0.7177 | 0.7036 | 98.0 |

TABLE 5
Toluene Resistance of Microfiber Nonwoven Synthetic Leather

| | IE1 | | CE1 | | CE2 | |
|---|---|---|---|---|---|---|
| | a | b | a | b | a | b |
| Weight One (g) | 2.5 | 2.6 | 2.6 | 2.5 | 2.4 | 2.5 |
| Weight Two (g) | 2.5 | 2.6 | 1.8 | 1.5 | 2.1 | 2 |
| Weight Three (g) | 2.5 | 2.6 | 1.8 | 1.5 | 2.1 | 2 |
| Retaining (%) | 100 | 100 | 41.7 | 15.4 | 81.8 | 58.3 |

| | | | |
|---|---|---|---|
| Average Retaining (%) | 100 | 28.5 | 70.1 |
| Leather Appearance | Good | Sticky and | Sticky and |
| | | Shrink | Shrink |

As shown in Tables 3 to 5, only specially designed polyurethane dispersions, i.e., prepared through monomeric aromatic diisocyanates at a specific concentration, may achieve the goal of this disclosure.

What is claimed is:

1. A polyurethane dispersion comprising:
a polyurethane prepolymer comprising, as polymerized units, by dry weight based on total dry weight of the polyurethane prepolymer, from 25% to 40%, a monomeric aromatic diisocyanate, and from 20% to 85%, a polyether polyol; and
an ionic surfactant.

2. The polyurethane dispersion according to claim 1, wherein the polyurethane prepolymer further comprises, as polymerized units, from 0.1% to 30% by dry weight based on total dry weight of the polyurethane prepolymer, a polyester polyol.

3. The polyurethane dispersion according to claim 1, wherein the polyurethane prepolymer has a % NCO from 3 to 10 percent.

4. The polyurethane dispersion according to claim 1, wherein organic solvent is not used in the preparation of the polyurethane prepolymer.

5. A microfiber nonwoven synthetic leather comprising a microfiber nonwoven fabric and a polyurethane dispersion, wherein the polyurethane dispersion comprises a polyurethane prepolymer and an ionic surfactant, wherein the polyurethane prepolymer comprises, as polymerized units, by dry weight based on total dry weight of the polyurethane prepolymer, from 25% to 40%, a monomeric aromatic diisocyanate, and from 20% to 85%, a polyether polyol.

6. The microfiber nonwoven synthetic leather according to claim 5, wherein the polyurethane prepolymer further comprises, as polymerized units, from 0.1% to 30% by dry weight based on total dry weight of the polyurethane prepolymer, a polyester polyol.

7. The microfiber nonwoven synthetic leather according to claim 5, wherein the polyurethane prepolymer has an isocyanate content of from 3 to 10 percent by weight based on the weight of the polyurethane prepolymer.

8. The microfiber nonwoven synthetic leather according to claim 5, wherein organic solvent is not used in the preparation of the polyurethane prepolymer.

9. A method of preparing the microfiber nonwoven synthetic leather, wherein it comprises a step of impregnating microfiber nonwoven fabrics into the polyurethane dispersion of claim 1.

10. The method of preparing the microfiber nonwoven synthetic leather according to claim 9, wherein it further comprises a step of subjecting the impregnated microfiber nonwoven fabrics to a toluene dissolution process.

11. The method of preparing the microfiber nonwoven synthetic leather according to claim 9, wherein it further comprises a step of subjecting the impregnated microfiber nonwoven fabrics to an alkaline dissolution process.
